(19) United States
(12) Patent Application Publication
(10) Pub. No.: US 2025/0276204 A1
(43) Pub. Date: Sep. 4, 2025

(54) Large Capacity Battery Compartment Fire Suppression System

(71) Applicant: AMPS Traction, LLC, Westerville, OH (US)

(72) Inventors: Douglas W. Bardwell, Westerville, OH (US); Brian J. Couchene, Newark, OH (US)

(21) Appl. No.: 19/064,297

(22) Filed: Feb. 26, 2025

Related U.S. Application Data
(60) Provisional application No. 63/559,651, filed on Feb. 29, 2024.

(51) Int. Cl. A62C 3/16; A62C 35/60; A62C 35/64; A62C 35/68; G08B 17/06; G08B 17/10; G08B 25/10

(52) U.S. Cl. CPC A62C 3/16; A62C 35/60; A62C 35/64; A62C 35/68; G08B 17/06; G08B 17/10; G08B 25/10

(57) ABSTRACT

The disclosure includes systems and methods for a large capacity battery compartment fire suppression system for use in vehicles and structures. An example system includes at least one battery compartment and at least one intake connector outside or within the battery compartment, vehicle, or structure. The system may also include an array of piping or tubing that connects the at least one intake connector to at least one dispersal device, such as a sprinkler. The intake connectors may be connected to an internal or external source extinguishing agent. The system may also include electronic telemetry sensors to monitor the thermal environment of the battery compartment and its surroundings. A method of using the large capacity battery compartment fire suppression system to manage thermal events in battery compartments in vehicles and structures is also provided.

### CROSS-REFERENCE TO RELATED APPLICATION

The present application is a continuation of U.S. Patent Application No. 63/559,651, filed Feb. 29, 2024, the contents of which is incorporated by reference.

### BACKGROUND

With current technologies adopting more battery-based electrical power than ever, an important concern includes how to handle thermal events and/or fires involving large battery packs. Current suppression systems are not adequate to handle conditions involving large battery pack thermal runaway. Since many common battery chemistries include lithium, foams and blankets are not able to extinguish these fires since under thermal runaway conditions, these batteries create their own oxygen. Accordingly, there exists a need for improved suppression systems that can quickly extinguish large battery pack fires.

### SUMMARY

Embodiments of the present disclosure include systems and methods for a battery compartment fire suppression system.

In a first aspect, a system for suppressing thermal events in large capacity battery compartments is provided. The system may comprise one or more connection mechanisms that may be connected to an external or internal source of extinguishing agent. Such sources may include local fire department connections, such as fire hydrants or tanker trucks, or external water tanks. Extinguishing agents may include, water, foam suppressants, gaseous CO2, wet chemical suppressants, dry chemical powders, and inert gases, among other possibilities. The system may also comprise one or more sprinklers placed within or surrounding the battery compartment. These sprinklers may be connected to the one or more connection mechanisms by means of an array of piping or tubing.

In a second aspect, a system for suppressing thermal events in large capacity battery compartments in vehicles is provided. The system may comprise one or more connection mechanisms placed on the exterior of the vehicle that may be connected to an external or internal source of extinguishing agent. These sources of extinguishing agent may be within the vehicle itself, external to the vehicle, or within a different module or section of the vehicle from the battery compartment. The one or more connection mechanisms may be connected by an array of piping or tubing to one or more sprinklers placed within or surrounding the battery compartment of the vehicle. The sprinklers may also be placed in areas of the vehicle separate from the battery compartment.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE FIGURES

FIG. 1 illustrates a large capacity battery compartment fire suppression system within a vehicle, according to an example embodiment.

FIG. 2 illustrates a large capacity battery compartment within a train locomotive, according to an example embodiment.

FIG. 3 illustrates a standalone view of a large capacity battery compartment fire suppression system, according to an example embodiment.

### DETAILED DESCRIPTION

Examples of methods and systems are described herein. It should be understood that the words “exemplary,” “example,” and “illustrative,” are used herein to mean “serving as an example, instance, or illustration.” Any embodiment or feature described herein as “exemplary,” “example,” or “illustrative,” is not necessarily to be construed as preferred or advantageous over other embodiments or features. Further, the exemplary embodiments described herein are not meant to be limiting. It will be readily understood that certain aspects of the disclosed systems and methods can be arranged and combined in a wide variety of different configurations.

It should be understood that the below embodiments, and other embodiments described herein, are provided for explanatory purposes, and are not intended to be limiting.

### I. OVERVIEW

The present invention relates to a fire suppression system designed for large-scale battery applications, integrating a containment structure that supports both direct water cooling and optional submersion-based suppression. The containment system features a dedicated fire hose connection(s), allowing external water sources to introduce coolant into the enclosure. When integrated into the design, this system can fill the containment area, submerging the battery modules to mitigate thermal runaway events and prevent fire propagation. However, submersion is not required for fire suppression, as the system's primary fire mitigation method relies on an integrated piping network designed to deliver targeted cooling to critical areas within the battery enclosure.

To enhance operational flexibility, the system may include strategically placed outlet orifices that allow for controlled drainage of water. These orifices can be adjusted externally, enabling firefighters or operators to regulate the outflow based on situational needs. By increasing or decreasing the flow rate, responders can manage water levels within the containment area, ensuring optimal cooling while maintaining an efficient water exchange process. Using these orifices conserves water on-site while maintaining a continuous cooling effect on the batteries, reducing overall water consumption during fire suppression efforts. This may be beneficial in situations where a fire hydrant is not readily available, requiring efficient use of limited water resources.

The design provides versatility in fire suppression response, accommodating different emergency scenarios. The piping system serves as the primary fire suppression mechanism, delivering direct cooling where needed, while the optional fill-up feature offers an additional layer of protection if required by the specific design or operational conditions. This adaptable approach ensures robust thermal runaway mitigation and significantly enhances safety in large battery energy storage applications, even in environments with limited resources.

In an example embodiment, a large capacity battery compartment fire suppression system may include one or more connection mechanisms on the outside of the battery compartment or the surrounding vehicle or structure to allow for the connection of internal or external sources of extinguishing agent. These connections may include quick release cam-lock type fire connections common to the local fire departments. These connections may also include other quick release connections used for materials transport. These connections may also be connected to an array of piping or tubing within the battery compartment, the surrounding vehicle, or the structure. The array of piping or tubing may be connected to one or more sprinklers or dispersal devices that may shower the batteries with the extinguishing agent provided by the internal or external source.

The internal source may be a water tank, fire extinguisher system, or a liquid, solid or gaseous extinguishing agent storage unit. The externals sources may include local fire department connections, fire department tanker trucks, fire hydrants, or external stores of water or similar extinguishing agents at locations such as fueling stations or train depots.

The large capacity battery compartment fire suppression system may shower the batteries with a significant volume of extinguishing agent without opening the side panels of the battery compartment(s). In some example embodiments, the system does not require the mobile unit to carry any onboard liquids or other extinguishing agent materials while providing a safe and effective cooling method in case of thermal runaway.

In some example embodiments, the large capacity battery compartment fire suppression system may include one or more connection mechanisms dispersed at different points outside of or within the battery compartment, vehicle, or structure. These connection mechanisms may each be of a different standard connection type, and/or they may each utilize different sources of extinguishing agent.

In some example embodiments, the large capacity battery compartment fire suppression system may include one or more electronic telemetry devices to monitor data regarding the thermal status of the battery compartment. Such data may include, but are not limited to: ambient temperature, the temperature of specific components, humidity, light, sound, and the presence of smoke. The one or more electronic telemetry devices may be connected to a cellular, wired, or wireless network to allow for the remote monitoring of the thermal environment and thermal events of the battery compartment.

In some example embodiments, the large capacity battery compartment fire suppression system may utilize one or more different extinguishing agent chemicals to manage different types of thermal events. One or more of these extinguishing agent chemicals may also be used in combination. The system may select, responsive to data received from the one or more electronic telemetry devices, one or more of the different extinguishing agent chemicals.

In an example embodiment, the large capacity battery compartment fire suppression system may include a battery compartment, which may be configured to house one or more battery modules; a main supply line configured to convey an extinguishing agent; one or more intake connectors operably coupled to the main supply line; one or more branch lines operably coupled to the main supply line; and one or more dispersal devices. The one or more dispersal devices may be operably coupled to the one or more branch lines and disposed so as to disperse the extinguishing agent throughout the battery compartment.

In an example embodiment, the system may further include an internal container, which may be configured to contain an internal source of the extinguishing agent and which may be operably coupled to the main supply line.

In an example embodiment, the system may further include one or more intake connectors that may be configured to be operably coupled to an external source of the extinguishing agent.

In an example embodiment, the system may further include one or more intake connectors that may include quick release cam-lock type connections.

In an example embodiment, the system may further include one or more intake connectors that may be a Storz connection, an instantaneous connection, or a threaded connection.

In an example embodiment, the system may include one or more intake connectors that may be configured to operably connect to a firefighting hose connector.

In an example embodiment, the system may further include one or more telemetry sensors within the battery compartment, wherein the telemetry sensors may be configured to record data indicative of at least one of: ambient temperature, one or more component temperatures, light emissions, sound emissions, or a presence of smoke.

In an example embodiment, the system may further include one or more telemetry sensors that may be connected to at least one of: a cellular network, a wired communication interface, or wireless communication interface.

In an example embodiment, the system may further include one or more telemetry sensors that may be configured to transmit information indicative of an occurrence or potential occurrences of one or more thermal events.

In an example embodiment, the one or more telemetry sensors may be configured to transmit information indicative of a severity assessment of the one or more thermal events.

In an example embodiment, a method of fire suppression in a large capacity battery compartment may include receiving, by one or more telemetry sensors within a battery compartment, thermal environment data; determining, based on the thermal environment data, an occurrence of a thermal event and a severity assessment of the thermal event; transmitting, via a communication interface, information indicative of the thermal event; connecting an external source of extinguishing agent from a local fire department to one or more intake connectors of a large battery compartment fire suppression system; and dispersing, by one or more dispersal devices connected to the one or more intake connectors of the large battery compartment fire suppression system, the extinguishing agent.

In an example embodiment, the external source of extinguishing agent may be a fire hydrant or fire tanker truck.

In an example embodiment, the external source of extinguishing agent may be an external storage tank within a fueling or maintenance facility.

In an example embodiment, the one or more intake connectors may be configured to be operably connected to one or more external sources of extinguishing agent.

In an example embodiment, at least two of the two or more intake connectors may be configured to be operably connected to one or more external sources containing one or more extinguishing agents.

In an example embodiment, the method may further include selecting, based on the occurrence of a thermal event and a severity assessment of the thermal event, at least one extinguishing agent from the one or more extinguishing agents; and dispersing, by the one or more dispersal devices connected to the one or more intake connectors of the large battery compartment fire suppression system, the selected extinguishing agent.

### II. EXAMPLE SYSTEMS

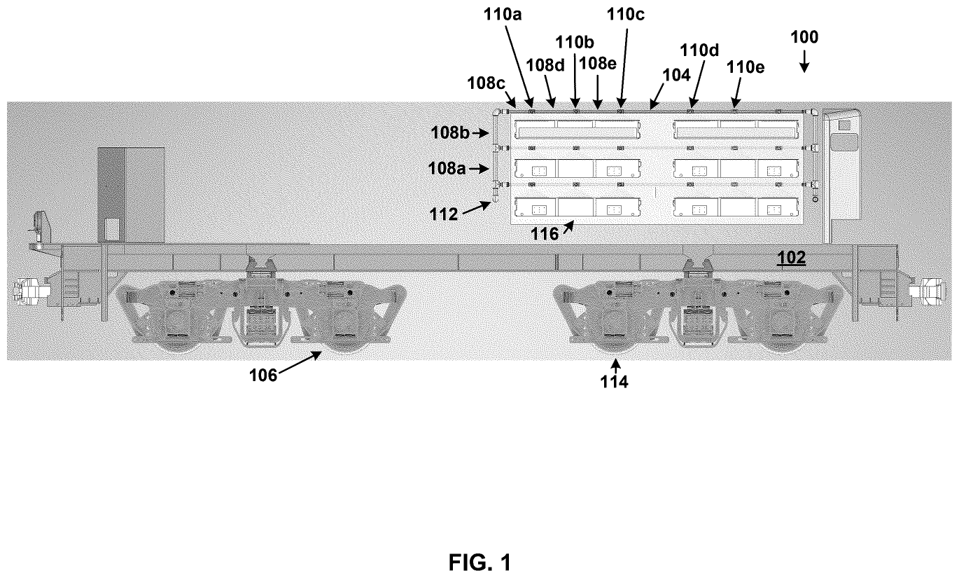

FIG. 1 illustrates an overview of the large capacity battery compartment fire suppression system disposed within a locomotive, according to an example embodiment. FIG. 1 illustrates a locomotive 100 having a large battery compartment or other propulsion equipment 116 within its chassis 102. The large battery compartment or other propulsion equipment 116 may include one or more battery cells arranged in an array. The locomotive may also include one or more wheels 106, and electrical, support, or propulsion equipment 114 mounted externally to the chassis 102. The locomotive also includes a connection mechanism 112 to an external source of extinguishing agent such as a fire hydrant or fire tanker trunk. The connection mechanism 112 may be operably connected to an array of piping or tubing 104. The array of piping or tubing 104 may be operably connected to one or more branch pipes or tubes 108a-108e, which may each be operably connected to one or more dispersal devices 110a-110e. The large capacity battery compartment fire suppression system may utilize the one or more dispersal devices 110a-110e to disperse extinguishing agent in the chassis 102, the large battery compartment or other propulsion equipment 116, their surroundings, or any electrical, support, or propulsion equipment 114 within or on the locomotive 100.

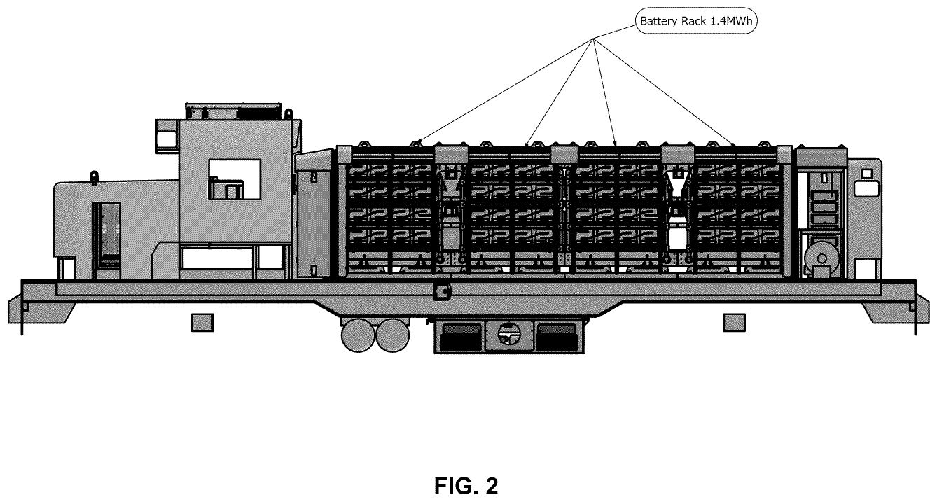

FIG. 2 illustrates an overview of a battery electric locomotive, according to an example embodiment. FIG. 2 illustrates a locomotive having a large battery rack, which includes multiple smaller constituent battery racks. The number, size, and location of the battery racks may vary based on the dimensions and technical specifications of the vehicle. The locomotive also comprises support equipment for the battery racks, including power electronics, a compressor, a battery thermal management system (BTMS), a front blower motor, a rear blower motor, charging ports, and a CCB 26 air brake. The battery racks may utilize the large capacity battery compartment fire suppression system specified in some example embodiments of the present disclosure to manage any thermal events within the battery compartment or other parts of the locomotive.

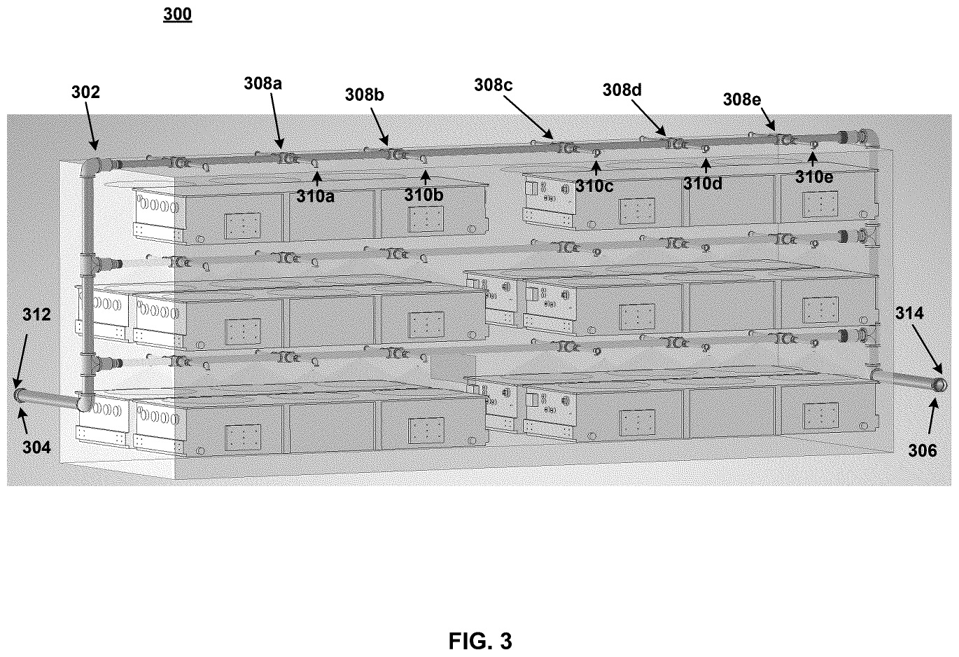

FIG. 3 illustrates a standalone view of the large capacity battery compartment fire suppression system 300, according to an example embodiment. FIG. 3 illustrates two intake connectors 304 and 306 at each end of the fire suppression system 300. These intake connectors 304 and 306 may connect to internal or external sources of extinguishing agent. These intake connectors 304 and 306 may also be quick release cam-lock type connections or couplers based on another method for chemical transport. The two connections are connected to an array of tubing or piping 302, which in turn may be operably connected to multiple branch lines 308a-308e. Each of these branch lines may be operably connected to one or more sprinklers or other dispersal devices, labeled 310a-310e. These sprinklers or other dispersal devices 310a-310e may be located within or outside of the battery compartment or other parts of a vehicle or structure.

In some example embodiments, fire suppression system 300 could include one or more intake caps 312, 314. In such scenarios, intake caps 312, 314 could be configured to prevent dirt from entering the piping of fire suppression system 300 when not in use. When used, intake cap 312 could be removed to introduce water into the system via intake connector 304 and intake cap 314 will stop the water from coming out of the other end of the line. Conversely, intake cap 314 could be removed to introduce water into the system via intake connector 306. In those situations, intake cap 312 may prevent water from coming out of intake connector 304. The intake caps 312, 314 could be threaded (e.g., like a fire hydrant cap) so as to screw onto intake connectors 304 and 306, respectively. Other types of pipe caps are possible and contemplated.

### III. CONCLUSION

The above detailed description describes various features and functions of the disclosed systems, devices, and methods with reference to the accompanying figures. In the figures, similar symbols typically identify similar components, unless context indicates otherwise. The illustrative embodiments described in the detailed description, figures, and claims are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

We claim:

1. A system comprising:
a battery compartment, wherein the battery compartment is configured to house one or more battery modules;
a main supply line configured to convey an extinguishing agent;
one or more intake connectors operably coupled to the main supply line;
one or more branch lines operably coupled to the main supply line; and
one or more dispersal devices, wherein the one or more dispersal devices are operably coupled to the one or more branch lines and disposed so as to disperse the extinguishing agent throughout the battery compartment.

2. The system of claim 1, further comprising an internal container, wherein the internal container is configured to contain an internal source of the extinguishing agent, wherein the internal container is operably coupled to the main supply line.

3. The system of claim 1, wherein the one or more intake connectors are configured to be operably coupled to an external source of the extinguishing agent.

4. The system of claim 1, wherein the one or more intake connectors comprise quick release cam-lock type connections.

5. The system of claim 1, wherein the one or more intake connectors comprise at least one of: a Storz connection, an instantaneous connection, or a threaded connection.

6. The system of claim 1, wherein the one or more intake connectors are configured to operably connect to a firefighting hose connector.

7. The system of claim 1, further comprising:
one or more telemetry sensors within the battery compartment, wherein the telemetry sensors are configured to record data indicative of at least one of: ambient temperature, one or more component temperatures, light emissions, sound emissions, or a presence of smoke.

8. The system of claim 7, wherein the one or more telemetry sensors is connected to at least one of: a cellular network, a wired communication interface, or wireless communication interface.

9. The system of claim 7, wherein the one or more telemetry sensors are configured to transmit information indicative of an occurrence or potential occurrences of one or more thermal events.

10. The system of claim 9, wherein the one or more telemetry sensors are configured to transmit information indicative of a severity assessment of the one or more thermal events.

11. A method comprising:
receiving, by one or more telemetry sensors within a battery compartment, thermal environment data;
determining, based on the thermal environment data, an occurrence of a thermal event and a severity assessment of the thermal event;
transmitting, via a communication interface, information indicative of the thermal event;
connecting an external source of an extinguishing agent from a local fire department to one or more intake connectors of a large battery compartment fire suppression system; and
dispersing, by one or more dispersal devices connected to the one or more intake connectors of the large battery compartment fire suppression system, the extinguishing agent.

12. The method of claim 11, wherein the external source of extinguishing agent is a fire hydrant or fire tanker truck.

13. The method of claim 11, wherein the external source of extinguishing agent is an external storage tank within a fueling or maintenance facility.

14. The method of claim 11, wherein the one or more intake connectors are configured to be operably connected to one or more external sources of extinguishing agent.

15. The method of claim 14, wherein at least one of the one or more intake connectors are configured to be operably connected to one or more external sources containing one or more extinguishing agents.

16. The method of claim 15, further comprising:
selecting, based on the occurrence of a thermal event and a severity assessment of the thermal event, at least one extinguishing agent from the one or more extinguishing agents; and
dispersing, by the one or more dispersal devices connected to the one or more intake connectors of the large battery compartment fire suppression system, the selected extinguishing agent.
